(19) United States
(12) Patent Application Publication
(10) Pub. No.: US 2016/0261946 A1
(43) Pub. Date: Sep. 8, 2016

(54) BLUETOOTH SPORTS HEADSET

(71) Applicants: SHENZHEN 3NOD DIGITAL TECHNOLOGY CO., LTD, Shenzhen (CN); SHENZHEN 3NOD ACOUSTICLINK CO., LTD, SHENZHEN (CN); GUANGXI 3NOD DIGITAL TECHNOLOGY CO., LTD, Beihai (CN)

(72) Inventor: Chuanbo CHEN, SHENZHEN (CN)

(21) Appl. No.: 15/153,329

(22) Filed: May 12, 2016

Related U.S. Application Data
(63) Continuation of application No. PCT/CN2015/085136, filed on Jul. 27, 2015.

(30) Foreign Application Priority Data
Feb. 12, 2015 (CN) 201520100946.5

(51) Int. Cl. H04R 1/10

(52) U.S. Cl. CPC H04R 1/1016; H04R 1/1041; H04R 1/105; H04R 1/1091; H04R 1/1058

(57) ABSTRACT

Disclosed is a Bluetooth sports headset, comprising a headset body, a wire control unit, and a headset wire. Two headset bodies having the same structure are respectively connected to the wire control unit via the headset wire; the wire control unit is configured to control the headset body which comprises a rear cover, a wire tail, a cell, an ear shell, a speaker, a front nozzle, and an earmuff. The cell is mounted in an inner cavity of the ear shell; the rear cover on a tail end surface of the ear shell; the earmuff on a head of the ear shell; the front nozzle on an inner side of the earmuff; the speaker on an inner side of the front nozzle and is opposing the head position of the ear shell; the wire tail on an outer surface of the ear shell and is connected to the headset wire.

### CROSS-REFERENCE TO RELATED APPLICATIONS

This application is a continuation of International Patent Application No. PCT/CN2015/085136, with an international filing date of Jul. 27, 2015, designating the United States, now pending, which is based on Chinese Patent Application No. 201520100946.5, filed Feb. 12, 2015. The contents of these specifications are incorporated herein by reference.

### BACKGROUND OF THE INVENTION

1. Field of the Invention

The present invention relates to the technical field of headsets, and more particularly relates to a Bluetooth sports headset.

2. Description of the Related Art

At present, Bluetooth sports headsets are mostly lightweight. However, due to the small volume of the products, generally headset cells have a poor duration capability. Further, the design concept of the headset is mainly to respectively arrange the cell and the Bluetooth module in the left and right headset cavities. Therefore, the headset may be subjected to an imbalance between the left side and the right side in terms of weight, and additionally the volume of the headset is large.

### SUMMARY OF THE INVENTION

To overcome the technical problem in the related art, the present invention is directed to providing a Bluetooth sports headset. According to the present invention, without increasing the dimensions of the headset, the cell capacity of the headset may be improved, and the left side and right side of the headset is more balanced in terms of weight.

To solve the problem as raised above, the present invention employs the following technical solution:

A Bluetooth sports headset is provided, comprising: a headset body, a wire control unit, and a headset wire; wherein two headset bodies having the same structure are respectively connected to the wire control unit via the headset wire, and the wire control unit is configured to control the headset body; and

the headset body comprises a rear cover, a wire tail, a cell, an ear shell, a speaker, a front nozzle, and an earmuff; wherein the cell is mounted in an inner cavity of the ear shell, the rear cover is mounted on a tail end surface of the ear shell, the earmuff is mounted on a head of the ear shell, the front nozzle is mounted on an inner side of the earmuff, the speaker is mounted on an inner side of the front nozzle and is opposing the head position of the ear shell, the wire tail is mounted on an outer surface of the ear shell, and the wire tail is connected to the headset wire.

A sound transmission mesh is mounted between the front nozzle and the ear shell.

The wire control unit comprises a Mic upper cover, a wire clip, a PCB board, and a Mic lower cover; wherein the Mic upper cover and the Mic lower cover form a wire control shell, the PCB board being arranged in the wire control shell and an operation button being arranged on the Mic upper cover; and the wire control shell is connected to the headset wire and is provided with the wire clip.

An ear wing is further mounted on the outer surface of the ear shell, the ear wing having an arc structure.

The cell employs a cylindrical cell.

Compared with the prior art, the beneficial effects of the present invention lie in that:

Without increasing the dimensions of the headset, the cell capacity of the headset may be improved, and the weight of the wearing parts of the headset is lowered. In addition, two headset bodies have the same structure, i.e., a symmetric design is achieved for the headset, such that the left side and right side of the headset is more balanced in terms of weight. In this way, wearing comfort of the product is enhanced.

### BRIEF DESCRIPTION OF THE DRAWINGS

For ease of description, the present invention is described in detail with reference to preferred embodiments and attached drawings hereinafter.

FIG. 1 is a schematic structural view of a Bluetooth sports headset according to the present invention; and

FIG. 2 is a partially exploded view of the Bluetooth sports headset according to the present invention.

Reference numerals and denotations thereof

1-rear cover, 2-wire tail, 3-cell, 4-ear shell, 5-speaker, 6-front nozzle, 7-sound transmission mesh, 8-earmuff, 12-ear wing, 14-Mic upper cover, 16-wire clip, 17-PCB board, 18-Mic lower cover, 100-headset body, 110-wire control unit, 120-headset wire

### DETAILED DESCRIPTION OF THE EMBODIMENTS

For better understanding of the present invention, the present invention is thoroughly described in combination with relevant drawings. The drawings illustrate preferred embodiments of the present invention. However, the present invention may be implemented in a plurality of forms or ways, and is not limited to the embodiments described herein. On the contrary, the embodiments described herein are intended to make the disclosure of the present invention more clearly and thoroughly understood.

Unless the context clearly requires otherwise, throughout the description and the claims, the technical and scientific terms, such as “comprise”, “comprising” and the like are to be construed in an inclusive sense as opposed to an exclusive or exhaustive sense; that is to say, in the sense of “including, but not limited to”. Words using the singular or plural number also include the plural or singular number respectively. Additionally, the terms “herein”, “above”, “below” and similar terms when used in the present application, shall refer to this application as a whole and not to any particular portions of this application.

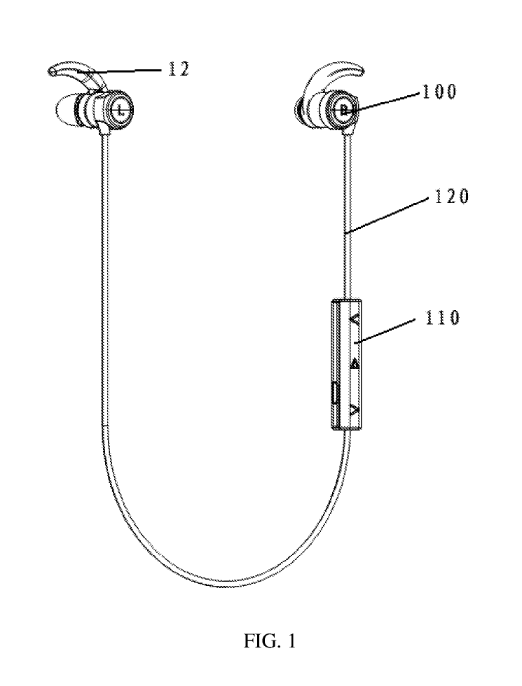

Referring to FIG. 1, the present invention provides a Bluetooth sports headset. The headset comprises: a headset body 100, a wire control unit 110, and a headset wire 120; wherein two headset bodies 100 having the same structure are connected via the headset wire 120, the wire control unit 110 is arranged on the headset wire 120, and the wire control unit 110 is configured to control the headset body 100.

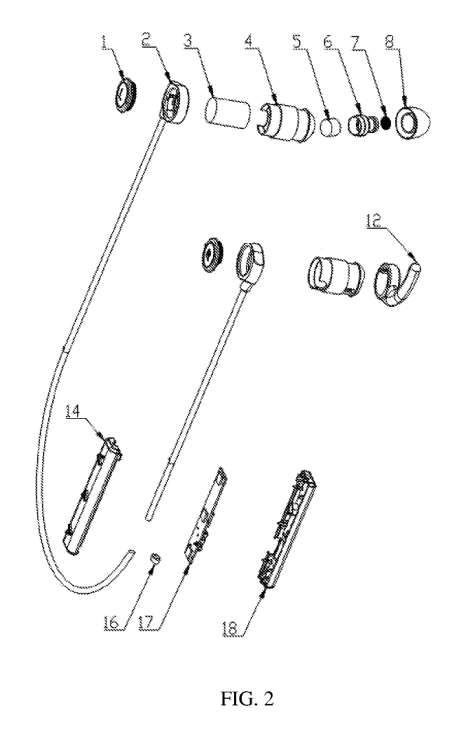

As illustrated in FIG. 2, the headset body 100 comprises a rear cover 1, a wire tail 2, a cell 3, an ear shell 4, a speaker 5, a front nozzle 6, a sound transmission mesh 7, and an earmuff 8; wherein the cell 3 is mounted in an inner cavity of the ear shell 4, the rear cover 1 is mounted on a tail end surface of the ear shell 4, and the earmuff 8 is mounted on a head of the ear shell 4. The front nozzle 6 is mounted on an inner side of the earmuff 8, and the speaker 5 is mounted on an inner side of the front nozzle 6 and is opposing the head position of the ear shell 4. The sound transmission mesh 7 is mounted between the front nozzle 6 and the ear shell 8. The wire tail 2 is mounted on an outer surface of the ear shell (4), the wire tail 2 is of an annular shape, and an outer surface thereof is connected to the headset wire 120.

The wire control unit 110 comprises a Mic upper cover 14, a wire clip 16, a PCB board 17, and a Mic lower cover 18; wherein the Mic upper cover 14 and the Mic lower cover 18 form a wire control shell, the PCB board 17 being arranged in the wire control shell and an operation button being arranged on the Mic upper cover 14. The wire control shell is connected to the headset wire 120 and is provided with the wire clip 16.

An ear wing 12 is further mounted on the outer surface of the ear shell 4 (referring to FIG. 1 and FIG. 2). The ear wing 12 has an arc structure, and is made from plastics and designed according to ergonomics. When a user does exercise while wearing the headset, the ear wing 12 is capable of snuggling close to the ears, thereby ensuring that the headset may not drop off due to vibrations caused by doing exercise.

As described above, the cell 3 is arranged in both of the two headset body 100, that is, a symmetric design is employed. In addition, the cell 3 employs a cylindrical cell, which may maximally utilize the space inside the inner cavity of the ear shell 4. In the meantime, the cell capacity of the entire headset is increased by 15% to 20%, and the area of the earmuff 8 is reduced by 10% to 15%. To be specific, the cell capacity of the headset is increased while the volume and weight of the wearing part of the headset are reduced.

As described above, the PCB board 17 is arranged in the wire control shell, and meanwhile the width and thickness of the wire control shell are increased by 20% and 10% respectively. Although the PCB board 17 is removed from the ear shell 4, and the size of the wire control unit 110 is slightly increased, the increase is very tiny and the change of this part would not cause any adverse effect to wearing of the user.

The above embodiment describes a preferred implementation manner of the present invention. However, the implementation manner of the present invention is not limited to the above embodiment. Any variations, polishments, substitutions, combinations, or simplifications, or the like equivalent replacements made to the present invention without departing from the spiritual essence and principle of the present invention shall all be covered within the protection scope of the present invention.

What is claimed is:

1. A Bluetooth sports headset, comprising: a headset body, a wire control unit, and a headset wire; wherein two headset bodies having the same structure are respectively connected to the wire control unit via the headset wire, and the wire control unit is configured to control the headset body; and
the headset body comprises a rear cover, a wire tail, a cell, an ear shell, a speaker, a front nozzle, and an earmuff; wherein the cell is mounted in an inner cavity of the ear shell, the rear cover is mounted on a tail end surface of the ear shell, the earmuff is mounted on a head of the ear shell, the front nozzle is mounted on an inner side of the earmuff, the speaker is mounted on an inner side of the front nozzle and is opposing the head position of the ear shell, the wire tail is mounted on an outer surface of the ear shell, and the wire tail is connected to the headset wire.

2. The Bluetooth sports headset according to claim 1, wherein a sound transmission mesh is mounted between the front nozzle and the ear shell.

3. The Bluetooth sports headset according to claim 1, wherein the wire control unit comprises a Mic upper cover, a wire clip, a PCB board, and a Mic lower cover; wherein the Mic upper cover and the Mic lower cover form a wire control shell, the PCB board being arranged in the wire control shell and an operation button being arranged on the Mic upper cover; and the wire control shell is connected to the headset wire and is provided with the wire clip.

4. The Bluetooth sports headset according to claim 1, wherein an ear wing is further mounted on the outer surface of the ear shell, the ear wing having an arc structure.

5. The Bluetooth sports headset according to claim 1, wherein the cell employs a cylindrical cell.
